(19) United States
(12) Patent Application Publication
(10) Pub. No.: US 2008/0191109 A1
(43) Pub. Date: Aug. 14, 2008

(54) Angle-adjustable display holder

(76) Inventor: Jhih-Jhang Liang, Changhua County (TW)

Correspondence Address: Liang, Jhih-Jhang, P.O. Box 44-2049, Taipei, 10668, omitted

(21) Appl. No.: 11/703,632

(22) Filed: Feb. 8, 2007

(51) Int. Cl. F16M 11/04

(52) U.S. Cl. 248/209

(57) ABSTRACT

The invention provides an angle-adjustable display holder, and more particularly a position-adjustable and angle-adjustable display holder, which is mainly composed of a first adjusting mechanism, a frame, a second adjusting mechanism and a third adjusting mechanism. Moving the first adjusting mechanism may move the display holder leftwards or rightwards. Moving the second adjusting mechanism may move a display held by the holder leftwards or rightwards. Moving the third adjusting mechanism can adjust an angle of the display.

### BACKGROUND OF THE INVENTION

(1) Field of the Invention

The invention relates to an angle-adjustable display holder composed of a first adjusting mechanism, a frame, a second adjusting mechanism and a third adjusting mechanism. Moving the first adjusting mechanism may move the display holder leftwards or rightwards. Moving the second adjusting mechanism may move a display held by the holder leftwards or rightwards. Moving the third adjusting mechanism can adjust an angle of the display.

(2) Description of the Prior Art

Displays may be applied to various applications, such as a television, a computer, a vehicle, a VCD or a DVD. However, most of the displays in various occasions are fixed, and the positions, the directions and the angles thereof cannot be adjusted. Even if some displays can be adjusted, only the positions, the directions or the angles can be adjusted. No mechanism can have the functions of adjusting the position, the direction and the angle. Although many manufacturers have spent a lot of spirit and resources to do the research and development, no definite effect is obtained.

### SUMMARY OF THE INVENTION

Although many manufacturers have spent a lot of time to improve the above-mentioned drawback, no effective method has been provided to overcome this drawback. In view of this, the present inventor has spent a lot of time and spirit to do improvements, tests and experiments according to various marketing experiences to provide an angle-adjustable display holder capable of solving the above-mentioned problem.

A main object of the invention is to provide an angle-adjustable display holder, which is mainly composed of a first adjusting mechanism, a frame, a second adjusting mechanism and a third adjusting mechanism. The first adjusting mechanism is composed of a rotatable head, fitting covers and a shaft rod. Upper and lower ends of the rotatable head are formed with shaft holes, and one side of the rotatable head is formed with an accommodating slot. Central portions of the fitting covers are formed with shaft holes. The shaft rod is fixed on a mounting seat. Moving the first adjusting mechanism can move the overall display holder leftwards or rightwards.

Another object of the invention is to provide an angle-adjustable display holder, wherein the second adjusting mechanism is composed of a shaft block and a pivoting block. The shaft block is formed with a shaft hole, and the pivoting block is formed with a shaft accommodating slot and a shaft hole. Moving the second adjusting mechanism can move a display held by the holder leftwards or rightwards.

Still another object of the invention is to provide an angle-adjustable display holder, wherein the third adjusting mechanism is composed of a base, a universal joint and an adjusting shaft seat. The base and the adjusting shaft seat are formed with arced slots for supporting and accommodating the universal joint. Moving the third adjusting mechanism can adjust an angle of the display.

Further aspects, objects, and desirable features of the invention will be better understood from the detailed description and drawings that follow in which various embodiments of the disclosed invention are illustrated by way of examples.

### BRIEF DESCRIPTION OF THE DRAWINGS

FIG. 1 is a pictorially exploded view showing a display holder according to the invention.

FIG. 2 is a pictorially assembled view showing the display holder according to the invention.

FIG. 3 is an assembled cross-sectional view showing the display holder according to the invention.

FIG. 4 is a schematic illustration showing an operation of the display holder according to the invention.

FIG. 5 is a schematic illustration showing another operation of the display holder according to the invention.

FIG. 6 is a schematic illustration showing still another operation of the display holder according to the invention.

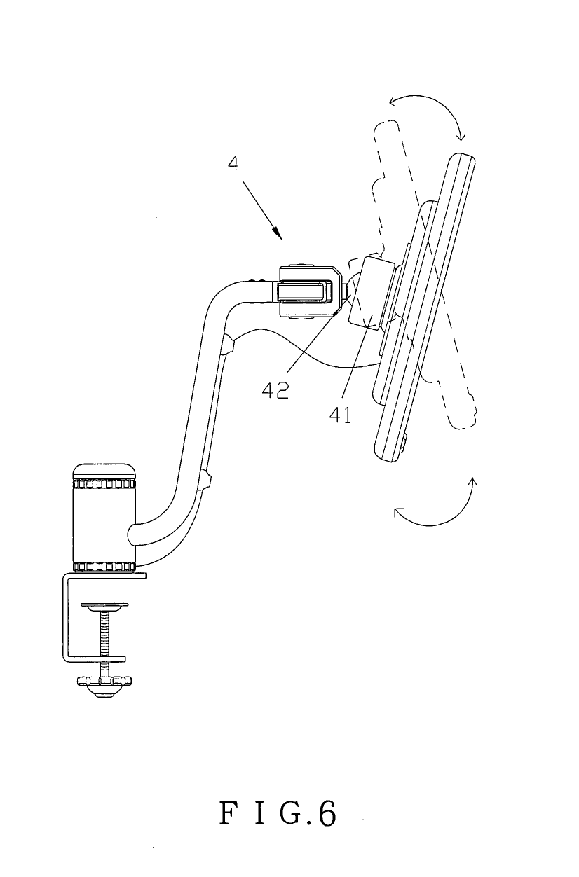

### DETAILED DESCRIPTION OF THE PREFERRED EMBODIMENTS

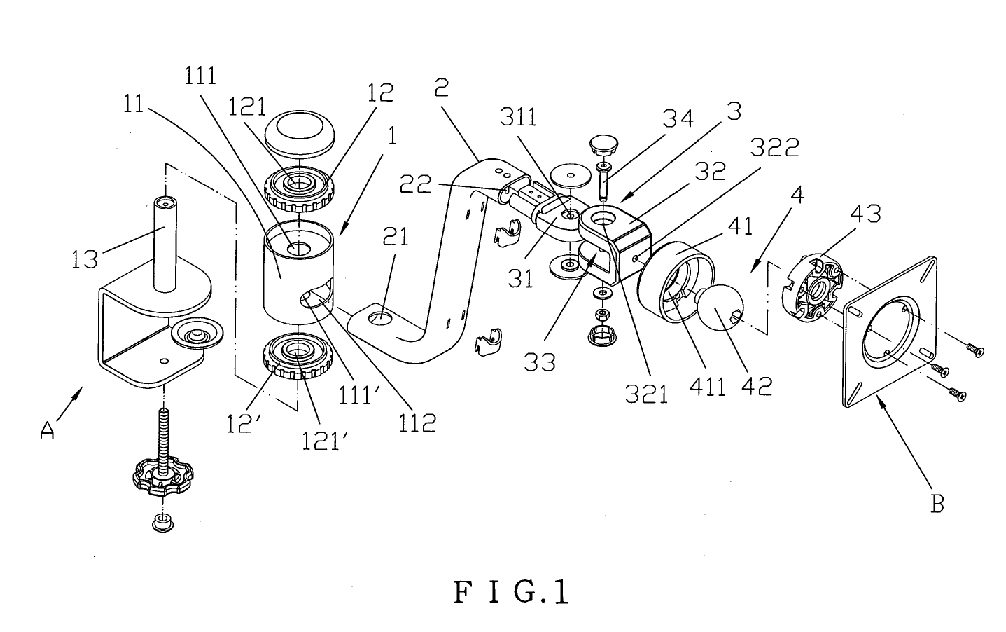

FIG. 1 is a pictorially exploded view showing an angle-adjustable display holder according to the invention. As shown in FIG. 1, the display holder is mainly composed of a first adjusting mechanism 1, a frame 2, a second adjusting mechanism 3 and a third adjusting mechanism 4. The first adjusting mechanism 1 is composed of a rotatable head 11, two fitting covers 12, 12′ and one shaft rod 13. The rotatable head 11 has upper and lower ends respectively formed with shaft holes 111, 111′, and a lateral side formed with an accommodating slot 112. Central portions of the fitting covers 12, 12′ are also formed with shaft holes 121, 121′. The shaft rod 13 is fixed on a mounting seat A. One end of the frame 2 is formed with a shaft hole 21, and the other end of the frame 2 is formed with an accommodating slot 22. The second adjusting mechanism 3 is composed of a shaft block 31 and a pivoting block 32. The shaft block 31 is formed with a shaft hole 311, and the pivoting block 32 is formed with a shaft accommodating slot 33 and a shaft hole 321. A rear side of the pivoting block 32 is formed with a screw hole 322. The third adjusting mechanism 4 is composed of a base 41, a universal joint 42 and an adjusting shaft seat 43. The base 41 and the adjusting shaft seat 43 are formed with arced slots 411 for supporting and accommodating the universal joint 42.

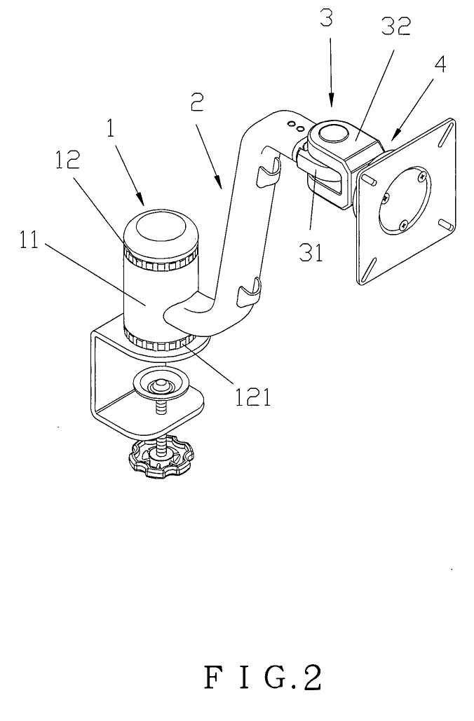

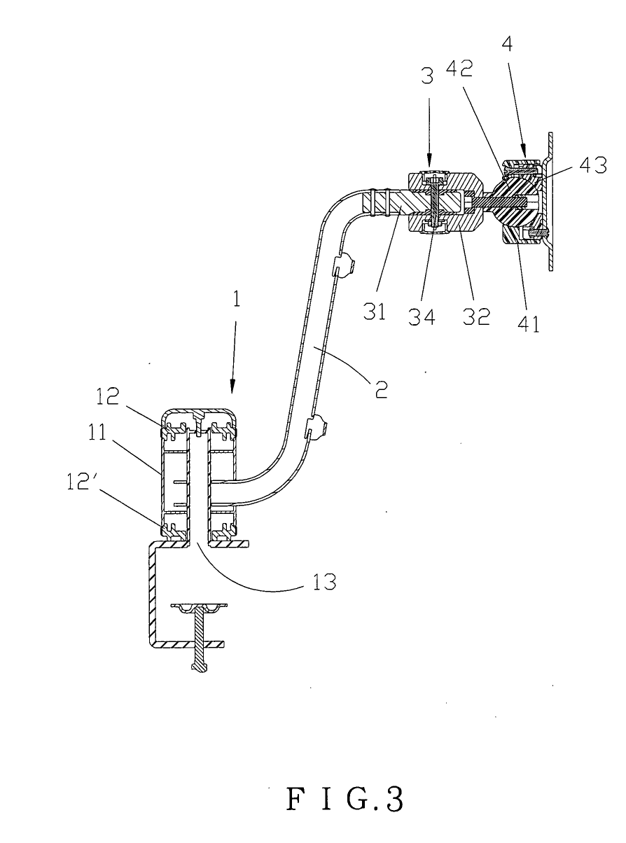

FIGS. 2 and 3 are respectively a pictorially assembled view and an assembled cross-sectional view showing the display holder according to the invention. As shown in FIGS. 2 and 3, when the display holder is being assembled, one end of the frame 2 is inserted into the accommodating slot 112 of the rotatable head 11 of the first adjusting mechanism 1, and the fitting covers 12, 12′ are respectively fit with the upper and lower ends of the rotatable head 11 so that the shaft holes 121, 121′, 111, 111′, 21 of the fitting covers 12, 12′, the rotatable head 11 and the frame 2 correspond to one another, and then the shaft rod 13 fixed on the mounting seat A penetrates through the shaft holes 121, 121′, 111, 111′, 21 and is then screwed. In addition, one end of the shaft block 31 of the second adjusting mechanism 3 is fixed into the accommodating slot 22 on the other end of the frame 2, and the other end of the shaft block 31 is inserted into the shaft accommodating slot 33 of the pivoting block 32 so that the shaft holes 311 and 321 of the shaft block 31 and the pivoting block 32 correspond to each other and a pivot pin 34 penetrates through the shaft holes 311 and 321 and then is screwed. The universal joint 42 of the third adjusting mechanism 4 is placed in the arced slot 411 of the base 41, and a screw is provided to screw the universal joint 42 and the base 41 to the screw hole 322 on the rear side of the pivoting block 32 of the second adjusting mechanism 3. The adjusting shaft seat 43 of the third adjusting mechanism 4 fits with the universal joint 42 so that the arced slot of the adjusting shaft seat 43 and the universal joint 42 can be combined, and then a display seat B is screwed to the adjusting shaft seat 43.

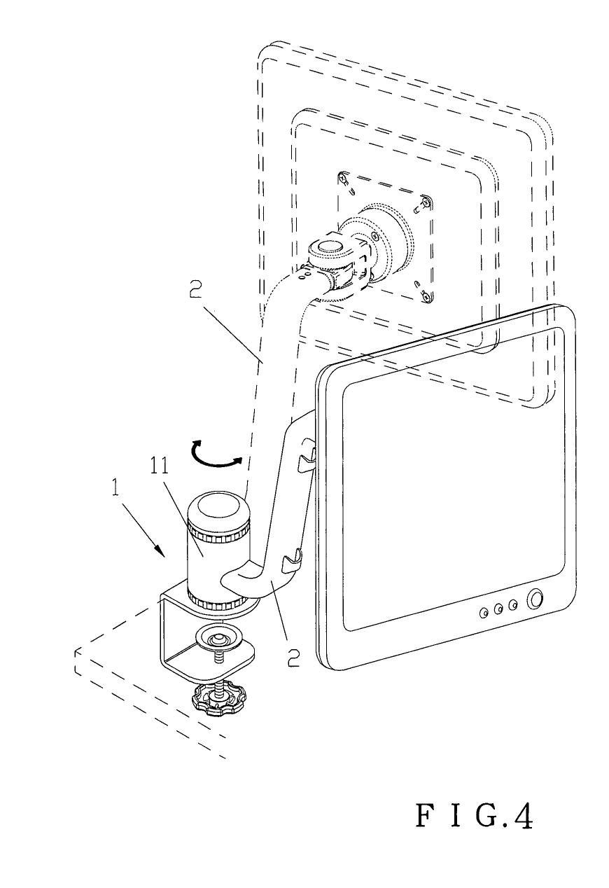

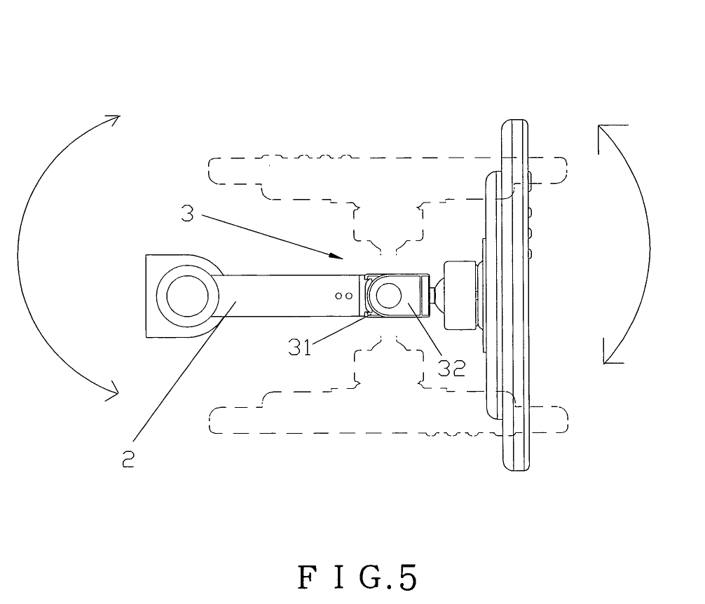

As shown in FIG. 4, when the display holder is to be totally moved leftwards or rightwards, the frame 2 is directly moved. Because one end of the frame 2 is placed in the accommodating slot 112 of the rotatable head 11 of the first adjusting mechanism 1 and the shaft rod 13 penetrates through the one end of the frame 2, the rotatable head 11 of the first adjusting mechanism 1 can be rotated about the shaft rod 13 so that the frame 2 may be moved leftwards or rightwards. When a display held by the holder is to be moved leftwards or rightwards, the display may be directly moved. In this case, the pivot pin 34 of the second adjusting mechanism 3 penetrates through the pivoting block 32 and the shaft block 31, so the pivoting block 32 is rotated about the pivot pin 34 and the display can be moved leftwards or rightwards, as shown in FIG. 5. When an angle of the display has to be adjusted, because the universal joint 42 of the third adjusting mechanism 4 has a circular arc surface and contacts the arced slot of the adjusting shaft seat 43, the display can be directly moved so that the angle of the display can be adjusted.

New characteristics and advantages of the invention covered by this document have been set forth in the foregoing description. It is to be expressly understood, however, that the drawings are for the purpose of illustration only and are not intended as a definition of the limits of the invention. Changes in methods, shapes, structures or devices may be made in details without exceeding the scope of the invention by those who are skilled in the art. The scope of the invention is, of course, defined in the language in which the appended claims are expressed.

What is claimed is:

1. An angle-adjustable display holder, comprising:
a first adjusting mechanism composed of a rotatable head and a shaft rod, wherein the rotatable head has upper and lower ends formed with shaft holes, and a lateral side formed with an accommodating slot, and the shaft rod is fixed on a mounting seat;
a frame having one end formed with a shaft hole and the other end formed with an accommodating slot;
a second adjusting mechanism composed of a shaft block and a pivoting block, which is formed with a shaft accommodating slot; and
a third adjusting mechanism composed of a base, a universal joint and an adjusting shaft seat, the base and the adjusting shaft seat being formed with arced slots for accommodating the universal joint,
wherein the one end of the frame is inserted into the accommodating slot of the rotatable head of the first adjusting mechanism, fitting covers fit with the upper and lower ends of the rotatable head so that the shaft holes of the fitting covers, the rotatable head and the frame correspond to one another, the shaft rod penetrates through the shaft holes of the fitting covers, the rotatable head and the frame and is then screwed, the shaft block of the second adjusting mechanism is inserted into the shaft accommodating slot of the pivoting block so that the shaft holes of the shaft block and the pivoting block correspond to each other, a pivot pin penetrates through the shaft holes of the shaft block and the pivoting block and is then screwed, the universal joint of the third adjusting mechanism is placed in the base so that the universal joint is placed in the arced slots of the base, a screw is provided to screw the universal joint and the base to a screw hole on a rear side of the pivoting block of the second adjusting mechanism, the adjusting shaft seat fits with the universal joint, the arced slots of the adjusting shaft seat and the universal joint are combined, and a display seat is screwed to the adjusting shaft seat.
